(19) United States
(12) Patent Application Publication
(10) Pub. No.: US 2004/0222936 A1
(43) Pub. Date: Nov. 11, 2004

(54) Multi-band dipole antenna

(76) Inventors: Zhen-Da Hung, Tu-Chen (TW); Lung-Sheng Tai, Tu-Chen (TW); Chia-Ming Kuo, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/630,597

(22) Filed: Jul. 29, 2003

(30) Foreign Application Priority Data
May 7, 2003 (TW) 92112495

(51) Int. Cl. H01Q 9/28

(52) U.S. Cl. 343/795; 343/700 MS

(57) ABSTRACT

A multi-band dipole antenna (1) for an electronic device includes an insulative substrate (10), a feeder (40) and a conductive element (20) including a ground portion (21) and a radiating portion (22) symmetrically disposed on the insulative substrate. The ground portion and the radiating portion symmetrically define an L-shaped first and second slots (214, 224). The feeder connecting to the conductive element includes an inner core (41) connecting to the radiating portion and an outer shield (42) connecting to the ground portion.

### BACKGROUND OF THE INVENTION

1. Field of the Invention

The present invention relates in general to antenna structures, and in particular to a multi-band dipole antenna structure in a wireless communication device.

2. Description of the Prior Art

The development of wireless local area network (WLAN) technology has been attended by the development of devices operating under the IEEE 802.11b standard (in the 2.45 GHz band) and the IEEE 802.11a standard (in the 5.25 GHz band). These devices benefit from multi-band antennas.

U.S. Pat. No. 5,892,486 discloses a conventional planar dipole antenna. The dipole antenna includes a ground plane having two parallel extensions, two dipole arms and a microstrip connected to the dipole arms. The parallel ground plane extensions are separated by a channel. The dipole arms are spaced from the distal end of the ground plane extensions. The microstrip has stubs connecting with the dipole arms and extending past the dipole arms in line with the extensions which can achieve a broad band. However, the antenna only has one operating frequency. Furthermore, the structure of the antenna occupies a larger space, which is counter to the trend toward miniaturization of portable electronic devices.

Hence, an improved antenna is desired to overcome the above-mentioned disadvantages of the prior art.

### BRIEF SUMMARY OF THE INVENTION

A primary object of the present invention is to provide a multi-band dipole antenna with broad operating bandwidth in a higher frequency.

Another object of the present invention is to provide a multi-band dipole antenna occupying smaller space.

A multi-band dipole antenna in accordance with the present invention for a wireless communication device comprises an insulative substrate, a conductive element attached on the substrate and a feeder connected to the conductive element. The conductive element includes a ground portion and a radiating portion symmetrically disposed on the insulative substrate. The ground portion includes a first ground plate and a second ground plate. The first and second ground plates are connected by a first connecting plate. An L-shaped first slot is defined between the first and second ground plates. The radiating portion comprises a first radiating plate and a second radiating plate. The first and second radiating plates are connected by a second connecting plate. An L-shaped second slot is defined between the first and second radiating plates. The feeder is a coaxial cable and includes an inner core connecting to the second connecting plate and an outer shield connecting to the first connecting plate.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a plan view of a multi-band dipole antenna in accordance with the present invention;

FIG. 2 is a plan view of the multi-band dipole antenna of FIG. 1, without showing a feeder of the multi-band dipole antenna;

FIG. 3 is a test chart recording for the multi-band dipole antenna of FIG. 1, showing Voltage Standing Wave Ratio (VSWR) as a function of frequency;

FIG. 4 is a horizontally polarized principle plane radiation pattern of the multi-band dipole antenna of FIG. 1 operating at a frequency of 2.45 GHz;

FIG. 5 is a vertically polarized principle plane radiation pattern of the multi-band dipole antenna of FIG. 1 operating at a frequency of 2.45 GHz;

FIG. 6 is a horizontally polarized principle plane radiation pattern of the multi-band dipole antenna of FIG. 1 operating at a frequency of 5.35 GHz;

FIG. 7 is a vertically polarized principle plane radiation pattern of the multi-band dipole antenna of FIG. 1 operating at a frequency of 5.35 GHz;

FIG. 8 is a horizontally polarized principle plane radiation pattern of the multi-band dipole antenna of FIG. 1 operating at a frequency of 5.725 GHz;

FIG. 9 is a vertically polarized principle plane radiation pattern of the multi-band dipole antenna of FIG. 1 operating at a frequency of 5.725 GHz.

### DETAILED DESCRIPTION OF THE INVENTION

Reference will now be made in detail to a preferred embodiment of the present invention.

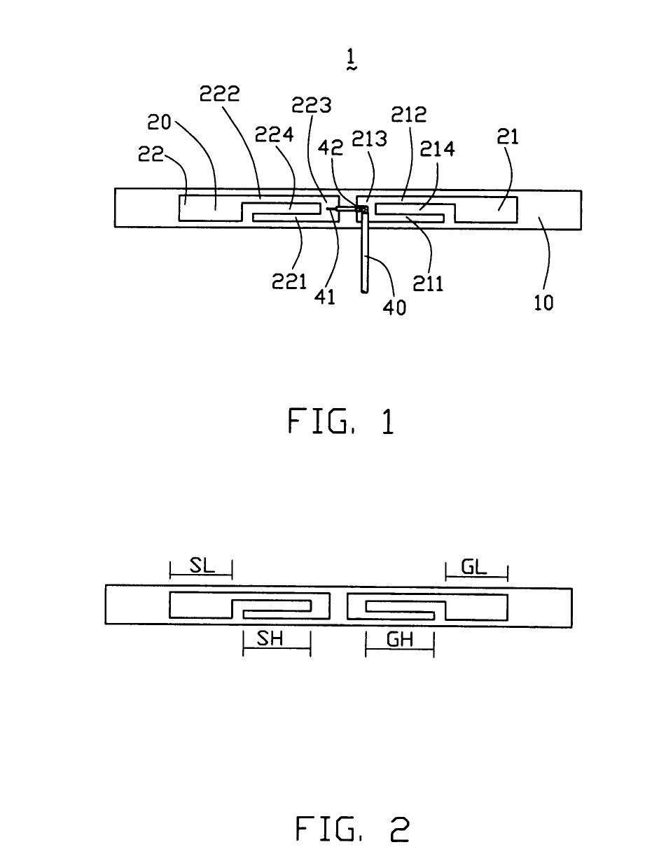

Referring to FIG. 1, a multi-band dipole antenna 1 in accordance with a preferred embodiment of the present invention comprises a planar insulative substrate 10, a conductive element 20 attached to the substrate 10 and a feeder 40 connected to the conductive element 20.

The conductive element 20 is a metal plate or a conductive layer disposed on one surface of the substrate 10 and includes a ground portion 21, and a radiating portion 22 which symmetrically disposed on the substrate 10. The ground portion 21 includes a first ground plate 211 and a second ground plate 212. The first and second ground plates 211, 212 are connected by a first connecting plate 213. The second ground plate 212 operates at a lower frequency and has a wide portion (not labeled) and a narrow portion (not labeled). The first ground plate 211 operates at a higher frequency and is disposed under the narrow portion. An L-shaped first slot 214 is defined between the first ground plate 211 and the second ground plate 212.

The structure of the radiating portion 22 is same to the ground portion 21 and includes a first radiating plate 221 and a second radiating plate 222. The first and second radiating plates 221, 222 are connected by a second connecting plate 223. The second radiating plate 222 operates at the lower frequency and has a wide portion (not labeled) and a narrow portion (not labeled). The first radiating plate 221 operates at the higher frequency and is disposed under the narrow portion. An L-shaped second slot 224 is defined between the first radiating plate 221 and the second radiating plate 222.

The first radiating plate 221 and the first ground plate 211 together constitute a first dipole unit. The second radiating 222 and the second ground plate 212 together constitute a second dipole unit.

The feeder 40 is a coaxial cable and comprises a conductive inner core 41, an inner dielectric layer (not labeled) around the inner core 41, a conductive outer shield 42 around the inner dielectric layer, and an outer dielectric layer (not labeled) around the conductive outer shield 42. A portion of the outer dielectric layer is stripped off to expose the outer shield 42, and a portion of the outer shield 42 and the inner dielectric layer is stripped off to expose a length of the inner core 41. The inner core 41 is soldered onto the second connecting plate 223, and the outer shield 42 is soldered onto the first connecting plate 213.

Referring to FIG. 2, the operating bandwidth of the multi-antenna 1 can be adjusted by adjusting the length of the SL, SH, GL and GH.

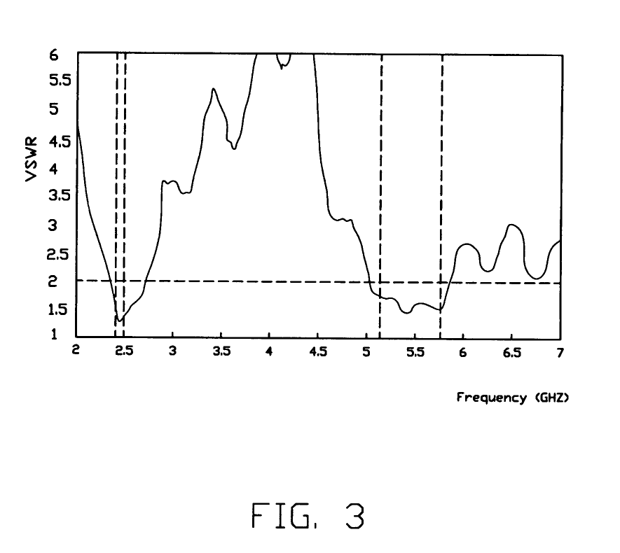

FIG. 3 shows a test chart recording of Voltage Standing Wave Ratio (VSWR) of the multi-band dipole antenna 1 as a function of frequency. Note that VSWR drops below the desirable maximum value “2” in the 2.4-2.5 GHz frequency band and in the 5.15-5.725 GHz frequency band, indicating acceptably efficient operation in these two wide frequency bands, which cover more than the total bandwidth of the 802.11a and 802.11b standards.

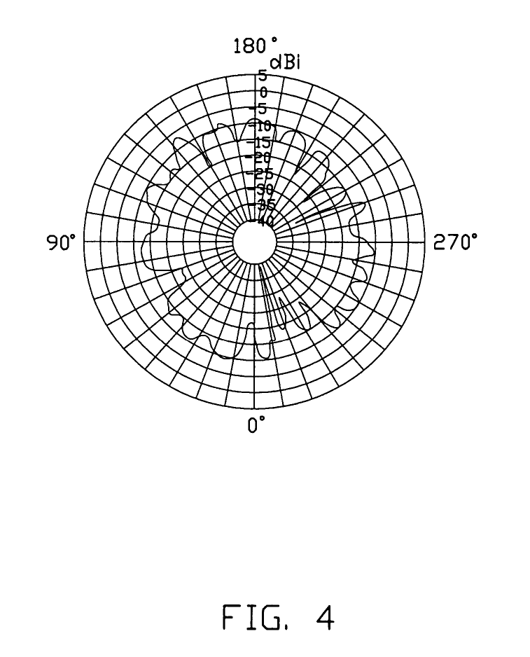

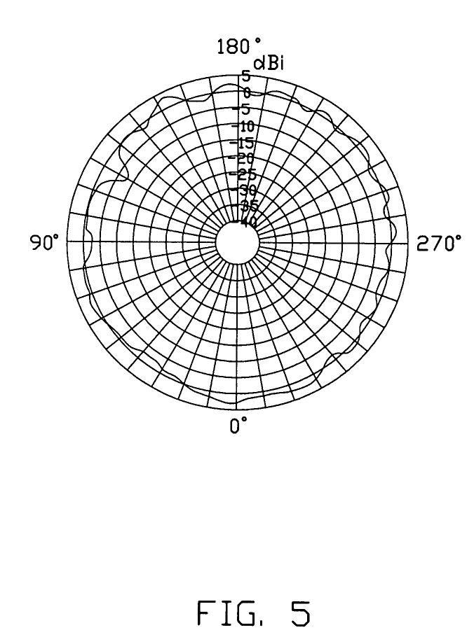

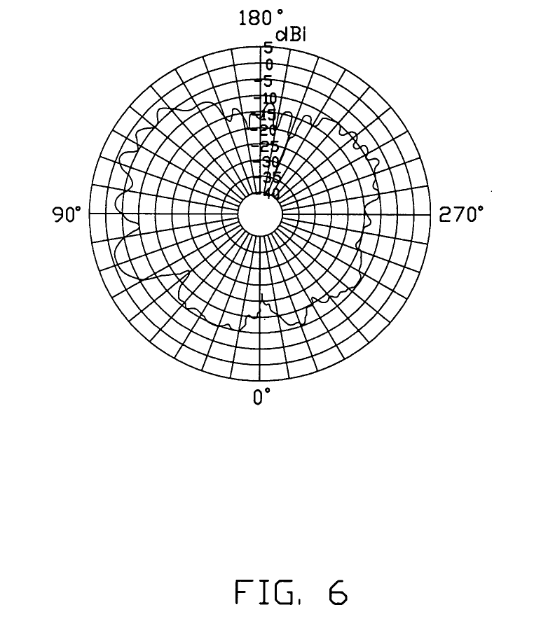

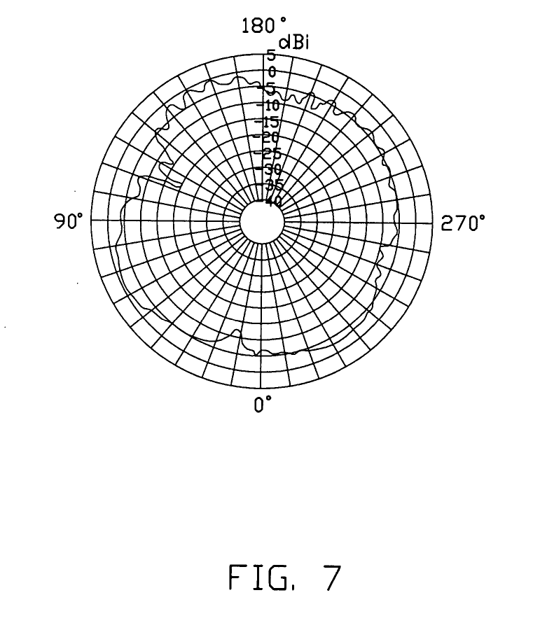

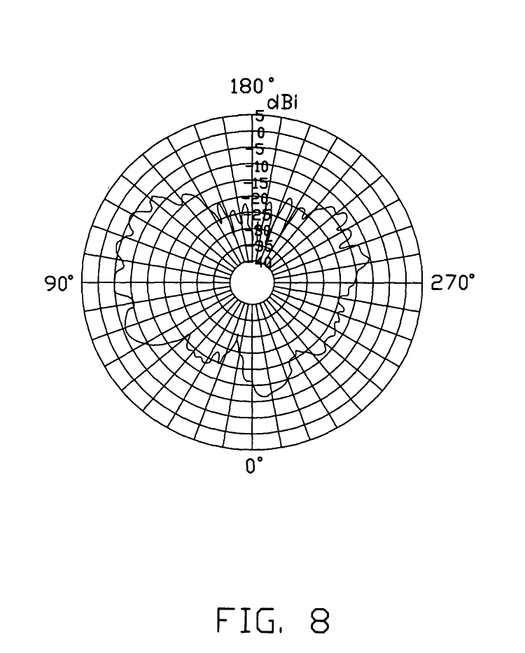

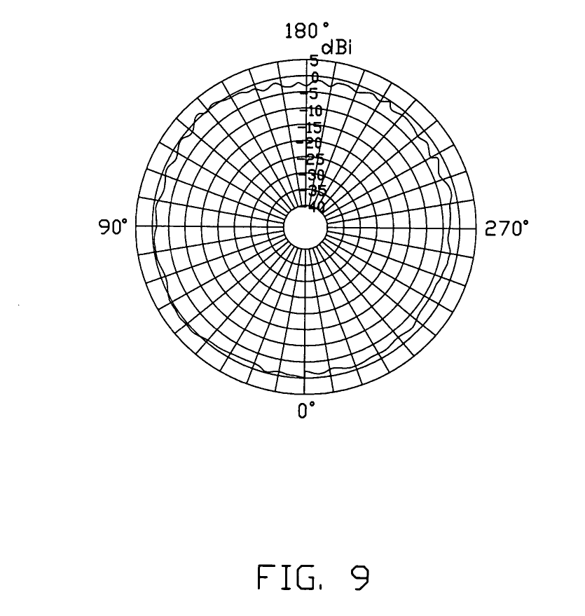

Referring to FIGS. 4 to 9, the figures respectively show horizontally and vertically polarized principle plane radiation patterns of the multi-band dipole antenna 1, which are tested respectively at the frequencies 2.45 GHz, 5.35 GHz and 5.725 GHz. Note that each radiation pattern is close to a corresponding optimal radiation pattern and there is no obvious radiating blind area.

The planar structure of the multi-band dipole antenna 1 of the present invention has the first dipole unit and the second dipole unit. The bandwidth of the second dipole unit can be effected by the first dipole unit in the higher frequency to achieve a broad bandwidth at the higher frequency. Furthermore, the multi-band dipole antenna has a smaller size and occupies smaller space than the structures of the prior arts, which achieves an efficiency of miniaturization.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-band dipole antenna adapted for a wireless communication device, comprising:
an insulative substrate;
a conductive element including a ground portion and a radiating portion symmetrically disposed on the insulative substrate, the ground portion and the radiating portion symmetrically defining an L-shaped first and second slots respectively; and
a feeder including an inner core connecting to the radiating portion and an outer shield connecting to the ground portion.

2. The multi-band dipole antenna as claimed in claim 1, wherein the ground portion comprises a first ground plate and a second ground plate, and the first slot is defined therebetween.

3. The multi-band dipole antenna as claimed in claim 2, wherein the ground portion has a first connecting plate connecting the first ground plate with the second ground plate.

4. The multi-band dipole antenna as claimed in claim 3, wherein the radiating portion comprises a first radiating plate and a second radiating plate, and the second slot is defined therebetween.

5. The multi-band dipole antenna as claimed in claim 4, wherein the radiating portion has a second connecting plate connecting the first radiating plate with the second radiating plate.

6. The multi-band dipole antenna as claimed in claim 5, wherein the inner core of the feeder electrically connects to the second connecting plate and the outer shield electrically connects to the first connecting plate.

7. A multi-band dipole antenna adapted for a wireless communication device, comprising:
an insulative substrate;
a first dipole unit including a first radiating plate and a first ground plate symmetrically disposed on the insulative substrate;
a second dipole unit including a second radiating plate and a second ground plate symmetrically disposed on the insulative substrate; and
a feeder cable including an inner core connecting to the first and second radiating plates and an outer shield connecting to the first and second ground plates;
wherein the first and second ground plates define an L-shaped first slot therebetween, and the first and second radiating plates define an L-shaped second slot therebetween symmetrical with the first slot.

8. The multi-band dipole antenna as claimed in claim 7, wherein the first and second ground plates are connected by a first connecting plate, the first and second radiating plates are connected by a second connecting plate, and the inner core of the feeder cable electrically connects to the second connecting plate and the outer shield electrically connects to the first connecting plate.

9. A multi-band dipole antenna comprising:
an insulative substrate;
a conductive element formed on one surface of the substrate and including a ground portion and a radiating portion spatially and oppositely arranged with each other in a mirror image relation along an imaginary center line wherein each of said ground portion and said radiating portion defines a rectangular configuration including long and short sides thereof with a slot starting from a long side toward while not reaching the short side, and
a feeder including an inner core and an outer core; wherein
the inner core is connected to the radiating portion and the outer core is connected to the ground portion.

10. The antenna as claimed in claim 9, wherein both an joint between the inner core and the radiating portion and another joint between the outer core and the ground portion are located very close to the imaginary center line.

11. The antenna as claimed in claim 9, wherein the slot extends toward said imaginary center line.

12. The antenna as claimed in claim 9, wherein the slot divides the corresponding radiating portion into two sections.

13. The antenna as claimed in claim 9, wherein the slot divides the corresponding ground portion into two sections.
